(19) United States
(12) Patent Application Publication
(10) Pub. No.: US 2014/0019590 A1
(43) Pub. Date: Jan. 16, 2014

(54) METHOD AND SYSTEM FOR PROVIDING MEDIA OPTIMIZATION

(71) Applicants: Philippe Piernot, Palo Alto, CA (US); Stephane Honore, Madrid (ES)

(72) Inventors: Philippe Piernot, Palo Alto, CA (US); Stephane Honore, Madrid (ES)

(73) Assignee: UNWIRED PLANET, LLC, Reno, NV (US)

(21) Appl. No.: 14/006,634

(22) PCT Filed: Mar. 21, 2012
(86) PCT No.: PCT/EP2012/055038

§ 371 Date: Sep. 20, 2013

Related U.S. Application Data
(60) Provisional application No. 61/454,947, filed on Mar. 21, 2011.

(51) Int. Cl. H04L 29/06

(52) U.S. Cl. CPC H04L 29/06476
USPC 709/217

(57) ABSTRACT

Methods and systems for providing media optimization are described. In one embodiment, a method for providing media optimization involves hosting a webpage at a content source, where the webpage contains media content and an instruction for optimizing the media content using an access network, receiving a request for the webpage at the content source from an end-user device, and sending the media content from the content source to the end-user device through the access network where the media content is optimized according to a technique specified in the instruction. Other embodiments are also described.

### BACKGROUND

Advances in Internet and carrier communications technologies have triggered an exponential upsurge in the amount of content that is available to communications devices. Service providers are faced with the challenge of effectively managing exponential growth in data traffic. For example, different content types, such as video, audio, and webpage, pose different demands for quality of service (QOS). Media content, such as video files, are often times compressed or cached by service providers before being delivered to an end-user device, such as a desktop computer, a laptop computer, a pad computer, or a smart phone. Specifically, the bit rate of the video files may be reduced. Additionally, the format of the video files may be converted to save bandwidth.

### SUMMARY

According to the invention, there is provided the method of claim 1, the method of claim 14, the method of claim 20, the method of claim 24, the method of claim 32 and the method of claim 33.

According to the invention, there is also provided the apparatus of claim 29, the computer program of claim 30 and the system of claim 31. Other embodiments of a system for providing media optimization are also described.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a schematic block diagram of one embodiment of a content. delivery system.

FIG. 2 depicts an embodiment of the media optimizer of FIG. 1.

FIG. 3 depicts an interface for accessing content at the content source of FIG. 1.

FIG. 4 depicts an embodiment of the content delivery system of FIG. 1 that includes a script server.

FIG. 5 illustrates exemplary message interactions between an end-user, a content source, and a script server in accordance with an embodiment of the invention.

FIG. 6 depicts an HTML page with an embedded script pointer in accordance with an embodiment of the invention.

FIG. 7 illustrates a set of exemplary message interactions between an end-user, an access network that includes a media optimizer and a script server, and a content source in accordance with an embodiment of the invention.

FIG. 8 illustrates a set of exemplary message interactions between an end-user, an access network that includes a media optimizer and a script server, and a content source in accordance with another embodiment of the invention.

FIG. 9 depicts a computer that includes a processor, memory, and a communications interface.

FIG. 10 is a process flow diagram of a method for providing media optimization in accordance with an embodiment of the invention.

FIG. 11 is a process flow diagram of a method for providing media optimization in accordance with another embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment. Rather, language referring to the features and advantages is understood to mean that a specific feature, advantage, or characteristic described in connection with an embodiment is included in at least one embodiment. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment. Thus, the phrases “in one embodiment,” “in an embodiment,” and similar language throughout this specification may, but do not necessarily, all refer to the same embodiment.

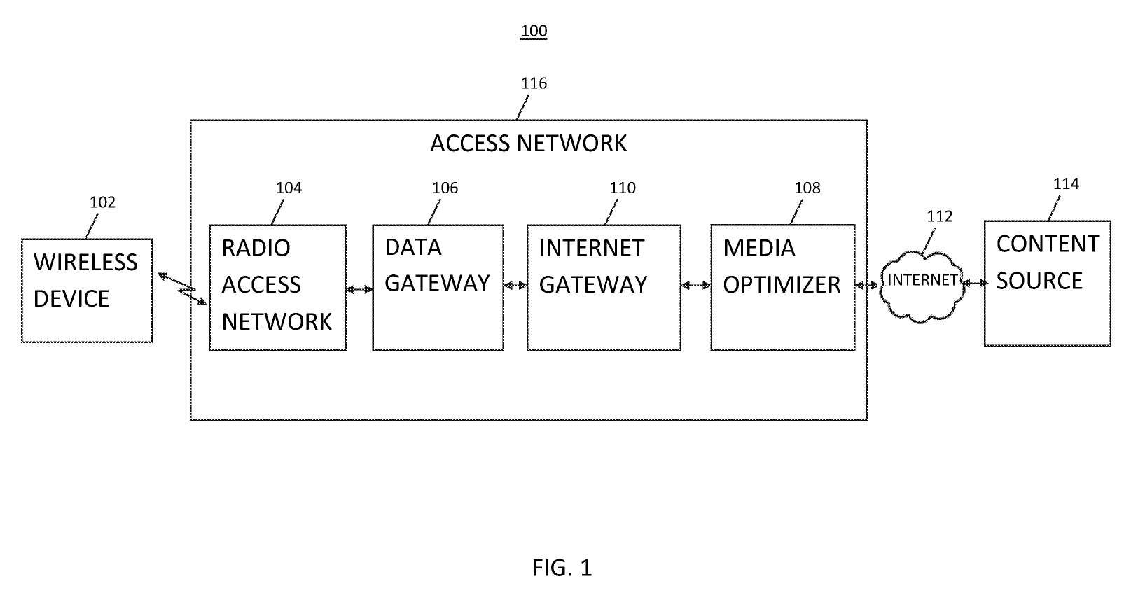

FIG. 1 depicts a schematic block diagram of one embodiment of a content delivery system 100. The content delivery system depicted in FIG. 1 includes a wireless device 102, an access network 116 that includes a radio access network 104, a data gateway 106, a media optimizer 108, and an Internet gateway 110, the Internet 112, and a content source 114. The access network provides access to the Internet. Typical access networks include wireless service provider networks (e.g. that offer 3G, 4G and/or WiFi access) and Internet Service Providers (ISPs) (e.g., that offer dial-up, digital subscriber line (DSL), and/or cable modem access). For example, the access network may be a wireless carrier network, such as a cellular network. A private enterprise network can also serve as an access network if client devices within the private enterprise network can access the Internet through the private enterprise network. The access network may be owned, managed, and/or administered by a single entity or different entities. For example, the access network may be owned, managed, and/or administered by a single wireless service provider, an ISP, or a private enterprise. Although the content delivery system is depicted and described with certain components and functionality, other embodiments of the content delivery system may include fewer or more components to implement less or more functionality. For example, the content delivery system may include more than one wireless device, more than one radio access network, more than one data gateway, more than one media optimizer, more than one Internet gateway, and/or more than one content source.

The content delivery system 100 may include any type of end-user device or devices configured to request content from the content source 114 on behalf of at least one end-user and/or to render received content for presenting to the end-user. An end-user device may be any type of communications device, such as a wireless device, a device that communicates through wires with other entity or entities, or a device that communicates wirelessly and through wires with other entity or entities. The content may be any type of content. For example, the content may include one or more webpage files, one or more text files, one or more image files, one or more audio files, or one or more video files, or any combination thereof. In an embodiment, the content includes media content, such as one or more image files, one or more audio files, or one or more video files, or any combination thereof. For example, the content may be a media stream, which is time sensitive media content that is constantly received by and presented to an end-user while being delivered by the content source. The media stream may be a video stream and/or a non-video stream such as an audio stream, or any combination thereof. For example, the media stream may be a live video and/or audio broadcast of an event over the Internet 112. In another example, the media stream is an Internet radio broadcast. In yet another example, the media stream is an on-demand video and/or audio stream. In an embodiment, the media stream corresponds to a single hyperlink or multiple hyperlinks, such as a Hypertext Transfer Protocol (HTTP) link or links, where media (e.g. video) delivery can be done using HTTP progressive download or adaptive streaming download mechanisms. The end-user may be a single person, multiple persons, other entity or entities. In the embodiment depicted in FIG. 1, the content delivery system includes an end-user device that is implemented as the wireless device 102.

The wireless device 102 of the content delivery system 100 can be any type of device that communicates using electromagnetic communications signals. The wireless device can support various different radio frequency (RF) communications protocols, including without limitation, Global System for Mobile communications (GSM), Universal Mobile Telecommunications System (UMTS), Code Division Multiple Access (CDMA), Worldwide Interoperability for Microwave Access (WiMax) and communications protocols as defined by the 3^{rd} Generation Partnership Project (3GPP) or the 3^{rd} Generation Partnership Project 2 (3GPP2), 4G Long Term Evolution (LTE) and Institute of Electrical and Electronics Engineers (IEEE) 802.16 standards bodies. Although some wireless communications protocols are identified herein, it should be understood that the present disclosure is not limited to the cited wireless communications protocols. In an embodiment, the wireless device is a handheld wireless device, such as a cell phone, a mobile phone, a smartphone, a pad computer, a Personal Digital Assistant (PDA), a handheld gaming device etc.

The radio access network 104 of the content delivery system 100 is configured to facilitate radio communications between at least one end-user device such as the wireless device 102 and a core network that includes the data gateway 106, the media optimizer 108, the Internet gateway 110, the Internet 112, and the content source 114. In an embodiment, the radio access network includes one or more base stations to facilitate communications among wireless devices that are within a communications range of the base stations. The base stations may be base station controllers (BSCs), radio network controller (RNCs) or other equivalent components. Each base station has at least one RF transceiver and the base stations communicate with the wireless devices using RF communications signals. The radio access network facilitates network communications among multiple wireless devices within the same radio access network and between wireless devices in other radio access networks and provides interfaces to facilitate communications with other entities, such as a Public Switched Telephone Network (PSTN), a Wide Area Network (WAN), the Internet, Internet servers, hosts, etc., which are outside of the radio access network. Data signals communicated between the wireless device and the radio access network include, but are not limited to, analog and/or digital RF signals (i.e., radio waves) for any type of communications mode, including text messaging, multimedia messaging, voice calling, and Internet browsing. The radio access network can support various different RF communications protocols, including without limitation, GSM, UMTS, CDMA, WiMax and communications protocols as defined by 3GPP, 3GPP2, or IEEE 802.16. Although some wireless communications protocols are identified herein, it should be understood that present disclosure is not limited to the cited wireless communications protocols.

Although the content delivery system 100 depicted in FIG. 1 includes the wireless device 102 and the radio access network 104, in other embodiments, the content delivery system includes at least one wired device instead of the wireless device and at least one wired communications network instead of the radio access network. The wired device may be a wired communications device that is configured to request content from the content source 114 on behalf of an end-user and/or to render received content for presenting to the end-user. The wired communications network may be a wired access network such as a dial-up, DSL, or cable modem based ISP network or a private enterprise network. The wired communications network facilitates communications between the wired communications device and the core network that includes the data gateway 106, the media optimizer 108, the Internet gateway 110, the Internet 112, and the content source 114. The wired device may be, for example, a computer equipped with an Ethernet card and the wired communications network may be an Ethernet local area network (LAN). In some embodiments, the content delivery system includes a combination of at least one wireless device, at least one radio access network, at least one wired device, and at least one wired communications network.

The data gateway 106 of the content delivery system 100 configures outgoing data access requests for use with one or more networks and configures incoming data for use by or display on an end-user device such as the wireless device 102. As shown, the data gateway interfaces directly with the radio access network 104 and the media optimizer 108, although other embodiments may include other intermediate functional elements. In one embodiment, the data gateway uses GPRS Tunneling Protocol (GTP) to communicate with the radio access network. Other embodiments may use other communications protocols. Other conventional operations of the data gateway are known. For example, the data gateway enables users of wireless devices to roam between cells, for example, to move between different locations within the radio access network, by tracking the wireless device's identity across the network. The data gateway may also provide authentication and data formatting functions.

The Internet gateway 110 of the content delivery system 100 provides a gateway for communications between at least one end-user device such as the wireless device 102 and Internet-connected hosts and/or servers in the Internet 112, which can also be referred to as the “cloud.” The Internet gateway may include a Serving General Packet Radio Service (GPRS) Support Node (SGSN) and a Gateway GPRS Support Node (GGSN). For example, the Internet gateway can be a Wireless Application Protocol (WAP) gateway that converts the WAP protocol used by the radio access network to the HTTP protocol used by the Internet. In an embodiment, the Internet gateway enables wireless devices to access multimedia content, such as Hyper Text Markup Language (HTML), compact HTML (cHTML), and extensible HTML (xHTML), which is stored on Internet-connected hosts and/or servers.

The media optimizer 108 of the content delivery system 100 is configured to optimize delivery of content that is requested by at least one end-user device, such as the wireless device 102. In the embodiment depicted in FIG. 1, the media optimizer can act as a proxy server, such as an HTTP proxy server, between the wireless device and the content source 114. In an embodiment, the media optimizer intercepts and interprets communications traffic between the wireless device 102 and the content source and applies one or more optimization techniques to content that is delivered between the wireless device and the content source, such as content that is delivered to the wireless device from the content source. Examples of the optimization techniques include, without limitation, codec transforming, encoding, size adaptation, bit rate adaptation, caching, transcoding, live stream handling, and bandwidth shaping (e.g. for HTTP progressive download and adaptive streaming). Although some optimization techniques are identified herein, it should be understood that present disclosure is not limited to the cited optimization techniques.

A content delivery network (CDN) can be used by a content provider or owner to optimize delivery of content from the content provider to an end-user device. For example, a content provider, such as the content source 114, may employ a mobile CDN for optimization of content that is to be delivered to subscribers of a cellular network. However, a CDN has one caveat: to optimize content in the CDN, the content needs to be injected from the content provider to the CDN. For example, a CDN typically requires that a content provider uses a content-injection application programming interface (API), which is provided by the CDN, to inject content to the CDN. Content-injection APIs usually differ from CDN to CDN. To use a specific CDN, a content provider has to use the API provided by the specific CDN. Thus, if the access network 116 offers an access network CDN to a content provider, the content provider needs to inject content into the access network CDN through the CDN API provided by the access network CDN.

In an embodiment, the access network 116 enables delivery optimization capabilities based on network assets of the access network and the requirement of a content provider. For example, a cellular network operator or a mobile operator's assets may include last mile delivery with network-aware capabilities (e.g. bandwidth, congestion, prioritization, latency), in-network content distribution (edge caching, edge broadcast) as Software as a Service (SaaS) for operator partners that require guaranteed delivery, and/or traffic mediation capabilities that allow the network operator to provide CDN—like capabilities without preliminary content injection. For specific content, a content provider can selectively activate one or more optimization features that are performed by the access network. For example, a content provider may not want to optimize media content, such as video content, if an end-user is downloading the media content to save for later viewing, e.g., with the option “save-as.” In an embodiment, a content provider may disallow the access network to perform transcoding or optimization (e.g. compression) or provide the end-user with a choice of enabling or disabling transcoding or optimization (e.g. compression) performed by the access network. In another example, a content provider or even an end-user might not want degraded quality just for the sake of smooth playing. High definition (HD) experience might be worth waiting for a full video clip to load even if it stalls sometimes. In an embodiment, a content provider may provide an end-user with a choice of selecting different qualities, such as different resolutions, of media content and/or enabling or disabling transcoding or optimization (e.g. compression) performed by the access network based on network congestion conditions. In another example, conventional media optimization techniques, such as video optimization techniques, are often sold for enhancing the end-user experience but the techniques are applied indiscriminately without approval of the content provider. In conventional systems where no CDN agreements are in place, a network operator triggers optimization in a unilateral fashion and does not provide the ability to let the content provider or owner or even an end-user to decide whether in-network optimization should be utilized. In addition, there is no formal process for a media content provider or owner to decide whether or not a media optimization platform of a carrier network deployed on the data path should apply optimization (e.g., compression or altering or caching) on its media content. In an embodiment, the content provider makes an agreement with the access network to provide an end-user with a choice of enabling or disabling in-network optimization of the access network.

In an embodiment, the optimization features that can be implemented upon consent of the end user include all of the functions of traditional CDNs and/or other functions that traditional CDNs cannot offer. Examples of optimization features include, without limitation, caching, media optimization, and/or content broadcast. Caching may be performed in various fashions, such as, on-the-fly. In an embodiment, the access network 116 performs edge caching, which involves the use of one or more caching servers to store content in a place or places closer to end users than the content provider. In another embodiment, the access network honors or follows a set of caching rules of a content provider. For example, the content provider may specify that most popular content, premium content, and/or a specific type of content needs to be cached by the access network. Media optimization can be performed in various fashions, such as, on-the-fly. In an embodiment, media optimization is performed by the access network based on network congestion conditions and/or device capabilities. Content broadcast may be performed in various fashions, such as, on-the-fly. In an embodiment, HD versions of live streams are fetched from a content provider by the access network. The access network can perform real-time Adaptive Streaming (AS) transformation and multi-stream delivery to devices such as handsets, which incur huge cost benefits in terms of processing and peering for the content provider.

In an embodiment, access network 116-based media optimization is triggered from a web site of the content source 114. For example, the wireless device 102, through an application such as a web browser, sends a request for media content that contains an optimization command that is generated from an instruction contained in a webpage that is hosted at the content source and specifies a technique for optimizing the media content using the access network. The optimization command, which may be sent jointly with a request for media content, may be in any form, which includes, without limitation, an HTTP header or headers, a URL modification or modifications (e.g. one or more additional query string parameters or one or more URL domain modification parameters), and/or an Internet Protocol (IP) header or headers. The optimization command can be interpreted by the access network to trigger at least one corresponding media optimization technique to be implemented on corresponding media content on the fly. In an embodiment, the access network obtains identification information from a request for media content, such as destination information (e.g. the destination IP of the request or the destination Uniform Resource Locators (URL)), sender information (e.g. the sender IP of the request), and/or the identification information of the request itself (e.g. a session number). In this embodiment, the access network uses the obtained identification information to identify a response to the request that contains media content. Once the corresponding content is identified, one or more media optimization techniques are applied to the content. For example, a request for media content and/or a response to the request may be in the form of a single IP packet or multiple IP packets. Each IP packet may include an HTTP segment, a Transmission Control Protocol (TCP) segment/header, and an IP segment/header. The HTTP segment may include an HTTP request message, such as an HTTP GET request message, which includes a start line, which is also referred to as the request line, and request headers. The request headers may contain a host URL and acceptable response formats. The request line may contain the “GET” operation, a request URL such as “video.html” that describes the resource of the host on which to perform the “GET” operation, and an HTTP version such as HTTP 1.1. The TCP segment may include TCP information, such as source port, destination port, and TCP sequence number. The IP segment may include IP information such as source IP address, destination IP address, and time to live (TTL). The intercepting of a request for media content and the triggering of a media optimization technique can be performed by a single device, such as the media optimizer 108, or performed individually or collaboratively by multiple devices. In an embodiment, the media optimizer intercepts a request for media content from the wireless device, where the request is made to the content source and contains an optimization command that specifies a technique for optimizing the media content using the access network, and where the optimization command is generated from an instruction contained in a webpage that is hosted at the content source. In addition, the media optimizer applies the technique for optimizing the media content to media content that is received as a response to the request.

Although the media optimizer 108 is shown in FIG. 1 as being located between the Internet gateway 110 and the Internet 112, the media optimizer can be located anywhere within the access network 116. In addition, the media optimizer can be located in a single device or distributed amongst multiple devices. In an embodiment, the media optimizer is located anywhere in the data path between the wireless device 102 and the content source 114. For example, the media optimizer may be located between the wireless device and the radio access network, between the radio access network and the data gateway, between the data gateway 106 and the Internet gateway, and/or between the Internet and the content source. In another embodiment, the media optimizer is integrated within or located within at least one component of the access network. In one example, the media optimizer may be integrated within the radio access network, the data gateway, and/or the Internet gateway. In another example, the media optimizer is located in a base station or a data center in the radio access network of a wireless carrier network such as a cellular network. In yet another example, the media optimizer is integrated within the Internet gateway of a wireless ISP or a wired ISP.

The content source 114 of the content delivery system 100 is configured to store content and to process a request for content from an end-user device such as the wireless device 102. The content source may store video content and/or non-video content such as text files, webpage files, image files, audio files, or any combination thereof. In an embodiment, the content source stores media content, processes a request for the media content, and streams requested media content to an end-user device over at least one streaming protocol. The content stored in the content source may be encoded or not encoded or compressed or uncompressed. The content source may serve content over a single transport protocol or multiple transport protocols. In an embodiment, the content source serves video content over HTTP such as HTTP-Adaptive Streaming (HTTP-AS) and/or real time streaming protocol (RTSP) or other similar protocols. The content source may be an HTTP server. In an embodiment, the content source is organized as a video web site, such as YouTube.com, Google Videos, Metacafe.com, and Hulu.com. Although the content delivery system is shown in FIG. 1 as including a single content source, the content delivery system may include multiple content sources in some embodiments. The multiple content sources may be distributed among different devices in a network. In an embodiment, the content source includes, employs, and/or owns media optimization assets, such as Internet CDN systems, that are independent from (e.g., not a part of) media optimization assets of the access network 116.

The content source 114 may enable one or more end-users to utilize media optimization functions of the access network 116. In an embodiment, the content source 114 hosts a webpage that contains media content and an instruction for optimizing the media content using the access network. The content source receives a request for the webpage from an end-user device such as the wireless device 102 and sends the media content to the end-user device through the access network, where the media content is optimized according to a technique specified in the instruction. In an embodiment, the instruction does not trigger any media optimization. The media content may be video content and/or non-video content such as text files, webpage files, image files, audio files, or any combination thereof.

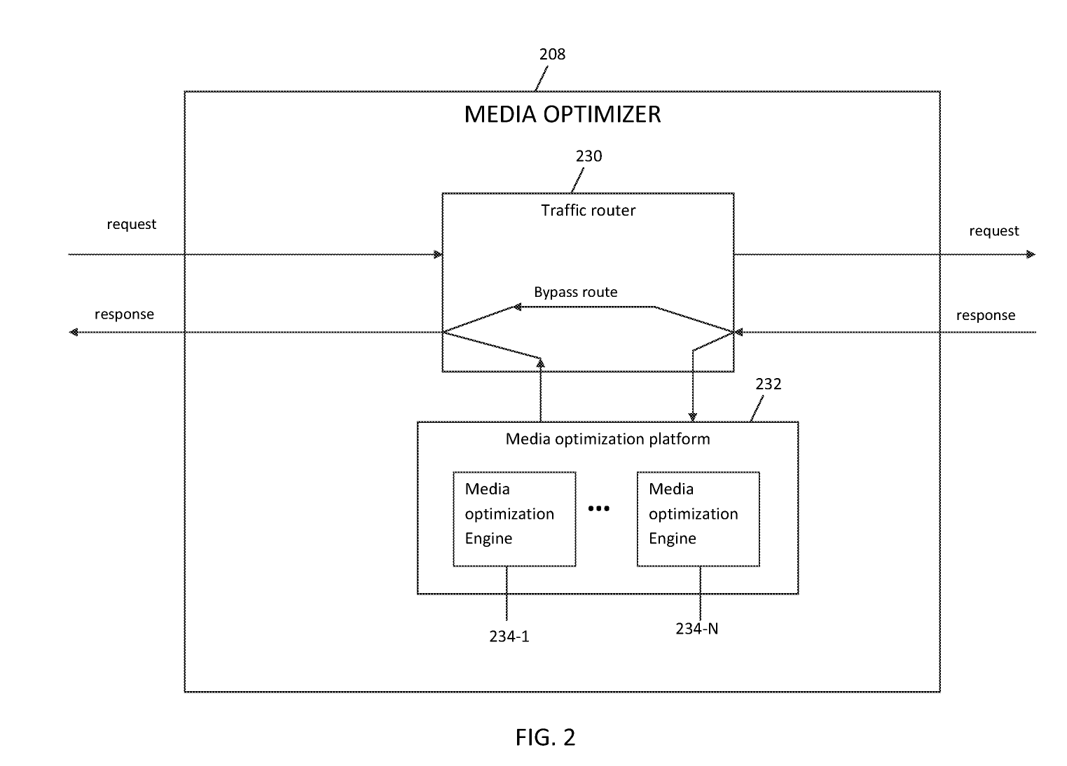

FIG. 2 depicts an embodiment of the media optimizer 108 of FIG. 1. In the embodiment depicted in FIG. 2, a media optimizer 208 includes a traffic router 230 and a media optimization platform 232 that includes media optimization engines 234-1 . . . 234-N, where N is a positive integer. Although the media optimizer 208 is depicted and described with certain components and functionality, other embodiments of the media optimizer 208 may include fewer or more components to implement less or more functionality. For example, the media optimization platform may include only one optimization engine or multiple optimization engines or may provide different optimization techniques (e.g. caching, transcoding, . . . ). In another example, the media optimizer 208 may include more than one traffic router and/or more than one media optimization platform. In an embodiment, components of the media optimizer 208 are distributed among different devices in a network. For example, the traffic router and the media optimization platform can be located in separate network devices and/or separate networks. In another example, the media optimization engines of the media optimization platform are located in separate network devices and/or separate networks.

The traffic router 230 is configured to intercept traffic between the wireless device 102 and the content source 114. In the embodiment depicted in FIG. 2, the traffic router monitors a request from the wireless device for an optimization command. The optimization command can be generated based on an instruction from the content source but actually issued by the wireless device upon requesting media content and may specify one or more techniques for optimizing the media content using the access network 116. In an embodiment, the traffic router interprets the optimization command, identifies optimization techniques that should be applied to the media content, and notifies the media optimization platform of the optimization techniques that should be applied. In an embodiment, the media optimizer 208, such as the traffic router or the media optimization platform 232, also operates on the request path as media optimization operates in a proxy mode. For example, in a proxy mode, the media optimizer issues the content request on behalf of an end-user device such as the wireless device—unless the content is actually available in a cached version locally—and when the requested content is received from the content source at the media optimizer, the media optimizer applies media optimization to the requested content.

The media optimization platform 232 is configured to apply the optimization techniques to media content that is received as a response to a request intercepted by the traffic router 230. In the embodiment depicted in FIG. 2, the media optimization engines 234-1 . . . 234-N process content based on optimization criteria, such as one or more characteristics of an intercepted request, a response to the intercepted request, an end-user, an end-user device, the access network 116, and/or the content source 114. Examples of some characteristics include device characteristics, network characteristics, environmental factors and socio-cultural factors. Examples of user data include the data service price plan a user is subscribed to (e.g., premium vs. standard). Examples of device characteristics include screen size and supported audio and video codecs. Examples of network characteristics include network technology, network topology and available network capacity. The optimization techniques used by the media optimization platform to optimize media streams can be any optimization mechanisms or procedures. The optimization techniques may include any function of a traditional CDN and/or other functions that may not be offered by traditional CDNs. Although the media optimization platform is depicted and described with certain components and functionality, other embodiments of the media optimization platform may include fewer or more components to implement less or more functionality. For example, the media optimization platform may include only one optimization engine.

Examples of the optimization techniques include, without limitation, codec transforming, encoding, size adaptation, bit rate adaptation, caching, transcoding, live stream handling, content broadcast, and bandwidth shaping (e.g., for HTTP progressive download and adaptive streaming). Caching may be performed on-the-fly. In an embodiment, at least one of the media optimization engines 234-1 . . . 234-N performs edge caching. In another embodiment, at least one of the media optimization engines honors or follows a set of caching rules of a content provider. For example, a content provider may specify that most popular content, premium content, and/or a specific type of content needs to be cached by one or more of the media optimization engines. In an embodiment, media optimization is performed by the access network on the fly, for example, based on network congestion conditions and/or device capabilities. Content broadcast may be performed on-the-fly. In an embodiment, HD versions of live streams are fetched from a content provider by at least one of the media optimization engines, which can perform real-time AS transformation and multi-stream delivery to devices such as handsets. In an embodiment, at least one of the media optimization engines is configured to perform bit rate adjustment and/or format conversion of at least one content element. For example, a media optimization engine may change coding parameters or the coding standard of a media file and/or adjust spatial and temporal resolution of a media file. A media optimization engine may encode an encoded media file, such as a video file, into another encoded media file of a different format or encode a non-encoded media file into an encoded media file. In another example, a media optimization engine may encode a content file into an encoded file that is more efficient from a delivery perceptive. At least one of the media optimization engines can perform bit rate adjustment and/or format conversion of one or more content elements according to characteristics of at least one end-user device such as the wireless device 102. The characteristics of the wireless device may include hardware characteristics, such as the physical dimensions and the resolution of the wireless device display, processor and memory specifications, and software characteristics, such as supported codecs and delivery protocols of the wireless device. The media optimization engines can also be used for the optimization of any type of content. For example, the media optimization engines can be used for the optimization of video content, non-video content such as text, webpage, image, audio, or any combination of video and non-video content. In an embodiment, each of the media optimization engines may be capable of optimizing a selected type of content. Although some optimization techniques are identified herein, it should be understood that present disclosure is not limited to the cited optimization techniques. In an embodiment, at least one of the media optimization engines honors or follows a set of rules of a content provider to perform media optimization.

An exemplary operation of the media optimizer 208 is described herein. If a request intercepted by the traffic router includes an optimization command, the traffic router directs the request or a response to the request or media content in the response to the media optimization platform 232 for optimization. The traffic router or the media optimization platform can issue the content request to a content provider or owner such as the content source 114 on behalf of an end-user device. If a request intercepted by the traffic router does not include an optimization command, the traffic router does not direct the response to the request or media content in the response to the media optimization platform. Instead, the traffic router directs the request to a bypass route, which does not include the media optimization platform. The bypass route may be located completely inside the traffic router, as shown in FIG. 2, located partially inside the traffic router, and/or located at least partially outside of the traffic router.

Conventional network operators typically apply in-network content optimization functions in a unilateral fashion (e.g., without agreement from a third party content provider). In an embodiment in accordance with the invention, third party content providers or owners and potentially end-users are allowed to decide whether or not to trigger in-network content optimization functions. Allowing entities other than the access network operator to control the application of in-network content optimization offers more transparency around when and how in-network content optimization is applied and can prevent network resources from being unnecessarily utilized, e.g., applying media optimization to media that is being downloaded for local storage (e.g., “save-as” use case). In an embodiment, the content provider or owner has the ability to delegate and offload some adaptation processing directly to the access network with the associated benefits in terms of latency reduction, network-aware delivery, Internet peering reduction and so forth. In an embodiment, a content provider or owner makes network information part of the end-user experience. An end-user can select his/her preferred quality. If content, such as a video clip, stalls, the end-user can select an “Auto” mode to trigger in-network content optimization functions on an as-needed basis. Selection of the “Auto” mode can result in an instant improvement in user experience. In an embodiment, the end-user can make the “Auto” mode the preferred default option. A content provider or owner can select the initial content quality or a content optimization option such as the “Auto” mode. For example, a content provider or owner can select the initial content quality or a content optimization option based on network status, to equate the end-user experience with the real-time network constraints. A content provider or owner can sell a higher quality content viewing experience (e.g., 1080p video content) to an end-user during congestion periods (e.g., peak-hour, congested cells, events . . . ) rather than exposing a quality option that cannot be honored by the access network. In an embodiment, some or all of the content quality options or content optimization options result from a negotiation between a content provider or owner of the content source 114 and a network operator of the access network 116. The negotiation maybe performed on-the-fly without the need to previously inject content into a conventional CDN system, which can ensure that the access network is capable of offering the content quality options or the content optimization options to improve the user experience.

The triggering of in-network content optimization functions is not disruptive to content providers or owners. Content providers or owners are free to utilize the in-network optimization functions or to decline their use. The in-network content optimization functions can be used in parallel, sequentially, or in any fashion with an existing content optimization asset of a content provider or owner (e.g., similar to the use of a CDN system). In an embodiment, the content source 114 employs one or more of the media optimization engines 234-1 . . . 234-N to perform at least one media optimization function at the content source. The media optimization engines may be located within the content source and/or outside the content source. The content source can use the media optimizer 108 or 208 of the access network and/or use its own media optimization engines.

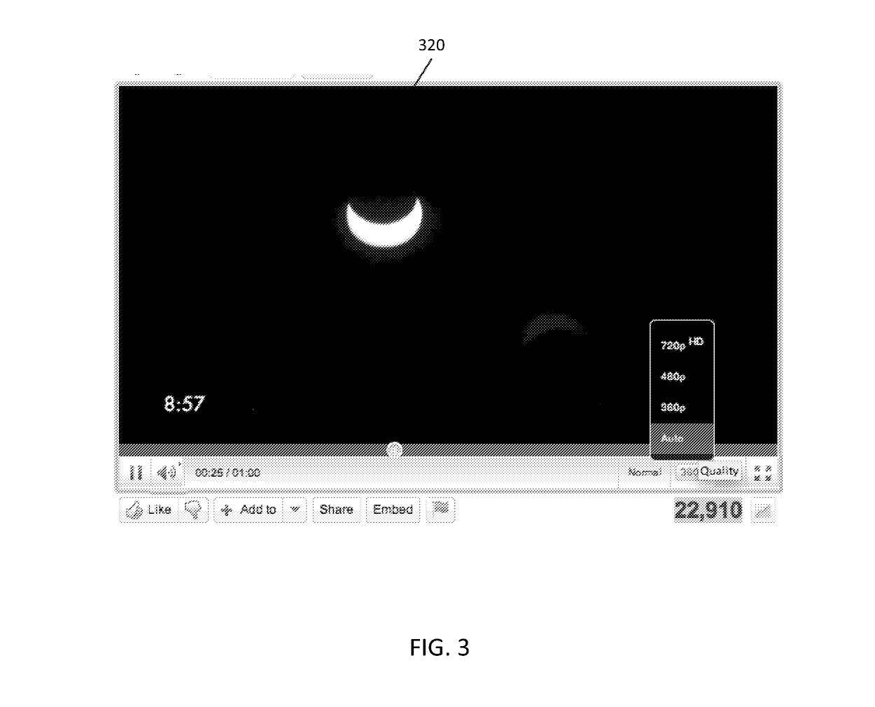

FIG. 3 depicts an interface 320 for accessing content at the content source 114 of FIG. 1. The interface depicted in FIG. 3 may be an interface of an application at an end-user device such as the wireless device 102 or an interface of the content source. For example, the interface may be an interface of a congestion-aware video player of the wireless device, a webpage that is loaded at a browser, such as a web browser, of the wireless device, and/or a webpage of the content source. The interface depicted in FIG. 3 can enable on-the-fly activation of video optimization from a content provider web site and by extension from an end-user device. In the embodiment of FIG. 3, the interface incorporates quality levels for video content with an “automatic” option (labeled as “Auto”), which can be selected by an end-user or a content provider or owner. The “Auto” mode, when selected, triggers or activates network-based video optimization to achieve a smooth experience. In an embodiment, the “Auto” mode triggers a media optimization technique that is implemented in the access network. In FIG. 3, the quality levels for video content include 360p, 480p, and 720p. However, the quality levels for video content that can be presented in the interface are not limited to the number and the values of the quality levels shown in FIG. 3. For example, the quality levels for video content may include 1080p, which may be labeled as High-Definition or “HD.” The access network 116, for example, the media optimizer 108 or 208, honors or follows the content owner or end-user selection and is free to trigger video optimization as needed when the “Auto” mode is selected. In an embodiment, media optimization options shown in a web page hosted in the content source results from a negotiation between a content provider or owner of the content source and a network operator of the access network. The negotiation may be performed on-the-fly, which can ensure that the access network is capable of implementing the media optimization options shown in a web page hosted in the content source. The access network may optimize the media based on real time network conditions.

In an exemplary operation, an end-user using the wireless device 102 uses a web browser to access a webpage at a website of the content source 114. The end-user selects the Auto mode in the webpage through the device's web browser. The access network 116 is notified to perform network-based video optimization on video content that is from the content source. The end-user then views the optimized video content, decides that the video quality is below his/her expectation, and selects the HD mode in the webpage through the web browser. The access network is notified to deliver video content that is from the content source in HD. For example, the access network may be informed not to perform network-based video optimization on video content that is from the content source. The end-user then views the HD video content, decides that the network is getting slow (e.g., the end-user switches from one access network, such as an ISP with WiFi to another access network, such as a 3G carrier network, with a lower data rate), and selects the “Auto” mode in the webpage through the web browser. The access network is notified to perform network-based video optimization on video content that is from the content source. The end-user then decides to download the video content for a local store (e.g., using a “save-as” function) and selects the HD mode in the webpage through the web browser. Alternatively, the HD mode is selected by the content source on behalf of the end-user. The access network is notified to deliver video content that is from the content source in HD mode and the end-user gets an original version of the video content.

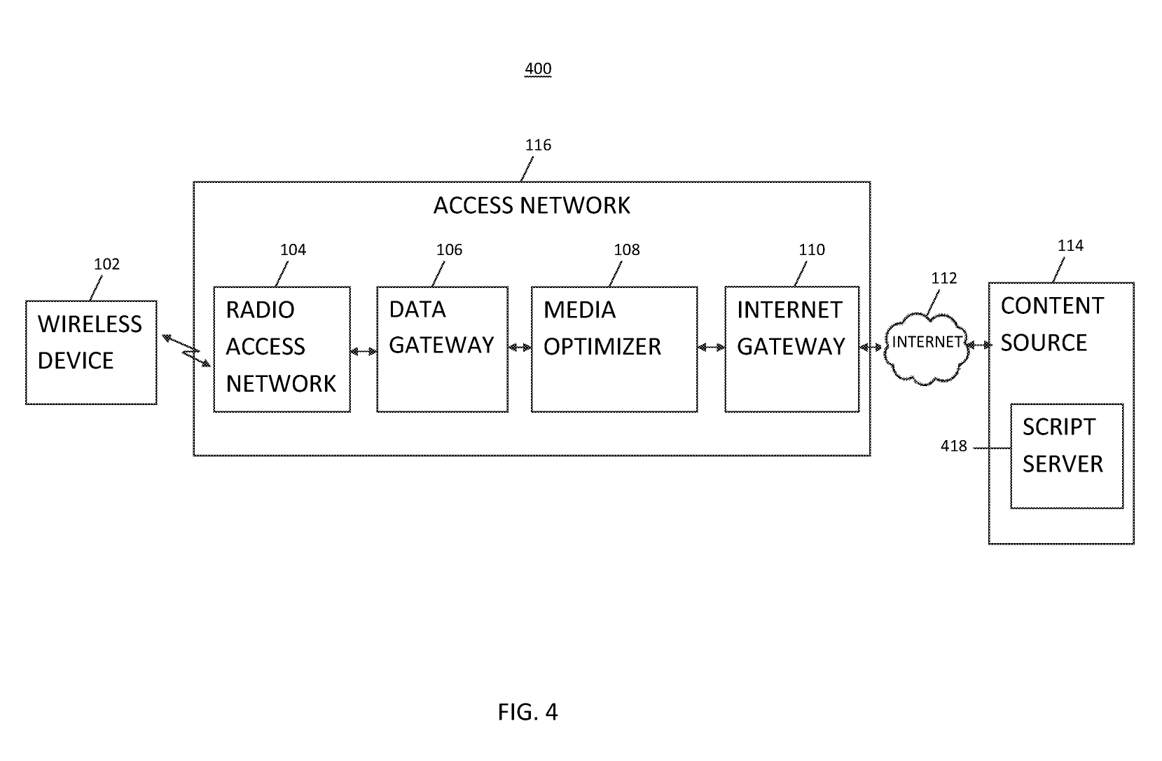

In an embodiment, informing an end-user of media optimization options via the content source 114 and triggering a media content optimization technique of the access network 116 is implemented using one or more scripts. FIG. 4 depicts an embodiment of the content delivery system 100 that includes a script server 418. The script server is configured to store at least one script, which can be a JavaScript, or any other script. The script server may be located anywhere in a content delivery system 400. Although the script server is shown in FIG. 4 as being part of the content source, the script server may be separate from the content source. For example, the script server may be integrated within the access network 116 and/or the Internet 112. In an embodiment, components of the script server are distributed among different devices in a network. For example, the script server can be located in separate network devices and/or separate networks.

The content source 114 may host a webpage that contains media content and an instruction for optimizing the media content using the access network 116. In an embodiment, the instruction is in the form of at least one script pointer. The script pointer may be embedded into the webpage by the content source and/or by the access network. In an embodiment, the script pointer points to a JavaScript, or other script, which is executed by an application, such as a web browser, of an end-user device. The script server 418 is configured to store the script that is identified (i.e., pointed to) by the script pointer in the webpage. A script stored in the script server may be developed by a content provider or owner and/or the access network.

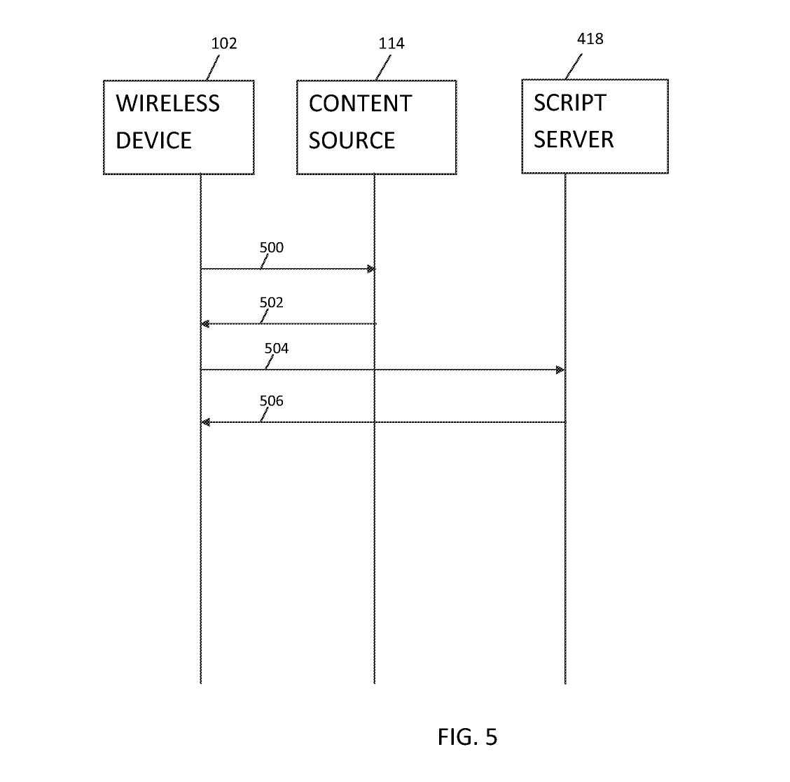

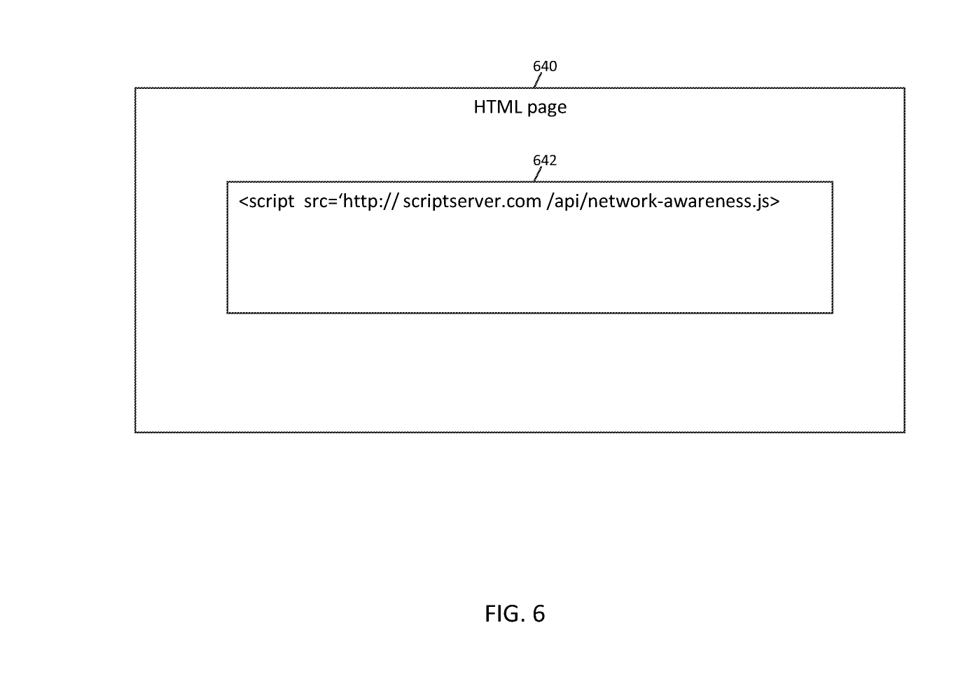

FIG. 5 illustrates exemplary message interactions between an end-user, the content source 114, and the script server 418. In a first operation, an HTTP request 500 is sent from the wireless device to the content source for a webpage that is hosted at the content source. The webpage may be an HTML page or other type of webpage. The content source generates and sends an HTTP response 502 back to the wireless device. The HTTP response includes the requested webpage. The requested webpage may be pre-embedded with a script pointer before an end-user requests the webpage. Alternatively, a script pointer is embedded in the requested webpage after the content source receives the HTTP request. In an embodiment, besides the content source, the access network, for example, the media optimizer 108 or 208, may embed a script pointer in the requested webpage. FIG. 6 illustrates an HTML page 640 that includes an embedded script pointer 642 that points to the Uniform Resource Locator (URL), “http ://scriptserver.com/api/network-awareness.js”. The URL “scriptserver.com” is merely used to represent the URL address of the script server. The URL address of the script server is not limited to the above-identified URL. In this example, the script pointer points to a script that when executed, runs an API in an end-user device. The API may generate a part of the interface 320 or the compete interface 320 of FIG. 3.

The HTTP response 502 is sent to the wireless device 102. Upon receiving the HTTP response with the embedded script pointer, the wireless device makes a script request 504 to the script server 418. In an embodiment, the script request is made in an HTTP request although other protocols are possible. In response to receiving the script request, the script server provides the requested script to the wireless device in a script response 506. The script is then run on the wireless device to implement, for example, an API that allows the end-user to select from media quality options and/or media optimization options that are implemented partially or completely by the access network 116 or to use a default media quality option and/or media optimization option that is implemented partially or completely by the access network 116. Although an API is provided as one example of a function of the script, scripts that perform other functions can be used.

In an embodiment, the script server 418 is integrated in the access network 116. In this embodiment, the access network performs media delivery optimization and provides a scripting service, which sets a content provider or owner, such as the content source 114, free from hosting scripts. Because a content provider or owner is free from hosting scripts, the access network can provide a valuable package service to the content provider or owner.

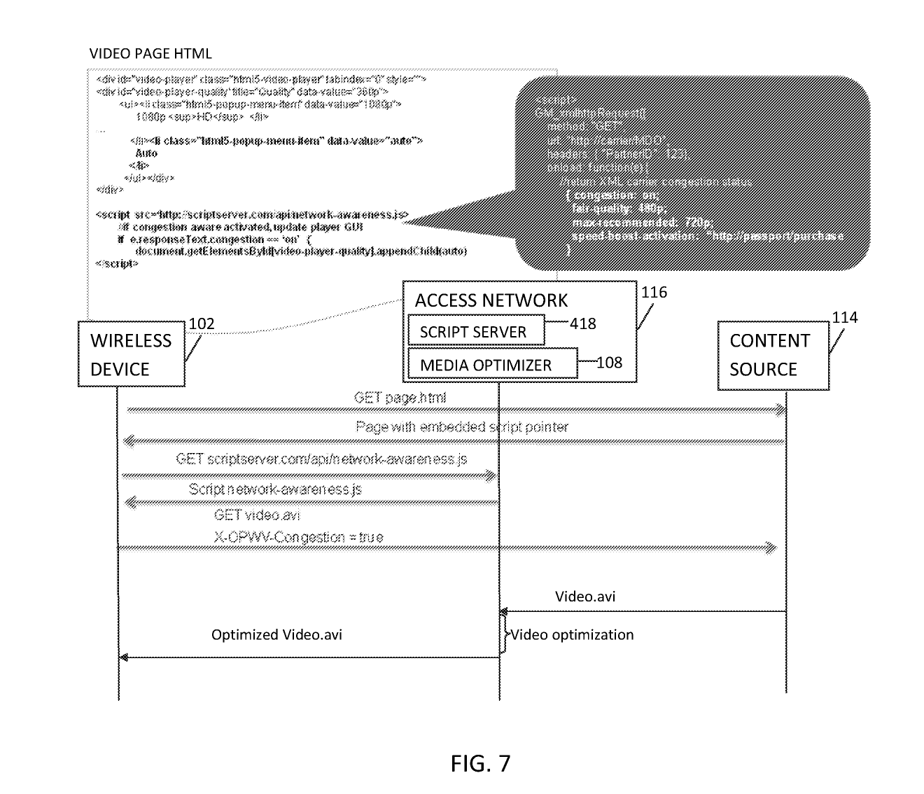

FIG. 7 illustrates a set of exemplary message interactions between an end-user, the access network 116 that includes the media optimizer 108 and the script server 418, and the content source 114. In a first operation, an HTTP GET request “GET page.html” is sent from the wireless device to the content source for a webpage containing video content. The content source generates and sends an HTTP response back to the wireless device. As shown in FIG. 7, the HTTP response includes the requested webpage with a script pointer. The script pointer may be inserted in the webpage by the content source and/or the access network. For example, the access network may intercept an HTTP response from the content source and insert the script pointer. An example of the webpage is shown in FIG. 7, which includes an embedded script pointer that points to the URL, “http://scriptserver.com/api/network-awareness.js”. The URL “scriptserver.com” is merely used to represent the URL address of the script server. The URL address of the script server is not limited to the above-identified URL. In this example, the script pointer points to a script that when executed, runs an API in the end-user device. An example of the script is shown in FIG. 7. As shown in the example script in FIG. 7, the end-user can purchase high speed delivery of content for a fee. The API may generate a part of the interface 320 or the compete interface 320 of FIG. 3.

Upon receiving the HTTP response with the embedded script pointer, the wireless device 102 makes an HTTP request “GET scriptserver.com/api/network-awareness.js” to the script server 418 of the access network 116. In response to receiving the script request, the script server provides the requested script to the wireless device. The wireless device runs the script on a web browser and selects from video quality options and/or video optimization options that are implemented by the access network or uses a default video quality option and/or video optimization option that is implemented by the access network. After a video optimization selection is made, the script enables the wireless device to send an HTTP GET message “GET video.avi” that includes an optimization command, such as a special HTTP header, which is used to trigger access network media optimization. In an embodiment, an HTTP header “X-OPWV-Congestion=true” is used as the optimization command to trigger video optimization by the media optimizer 108. The video optimization may be performed by the media optimizer only when the network is congested, e.g., the data rate of the access network is lower than a predetermined threshold. Specifically, the media optimizer can transparently intercept the HTTP GET message with the special HTTP header and interprets the HTTP header to trigger in-access network video optimization. After receiving the HTTP request for video content, the content source 114 sends the video content identified by “video.avi” to the requesting wireless device. The media optimizer intercepts the video content, performs video optimization as needed, and sends the video content (in optimized form or in native form) to the wireless device. In an embodiment, the media optimizer determines that the requested video content (identified by “video.avi”) is not locally accessible (e.g., cached or optimized previously) in the access network and sends a request for video content on behalf of the wireless device. When the requested video content is received from the content source at the media optimizer, the media optimizer applies media optimization on the requested content. In another embodiment, a field within an IP header of an HTTP GET message is used instead of a special HTTP header to trigger access network media optimization.

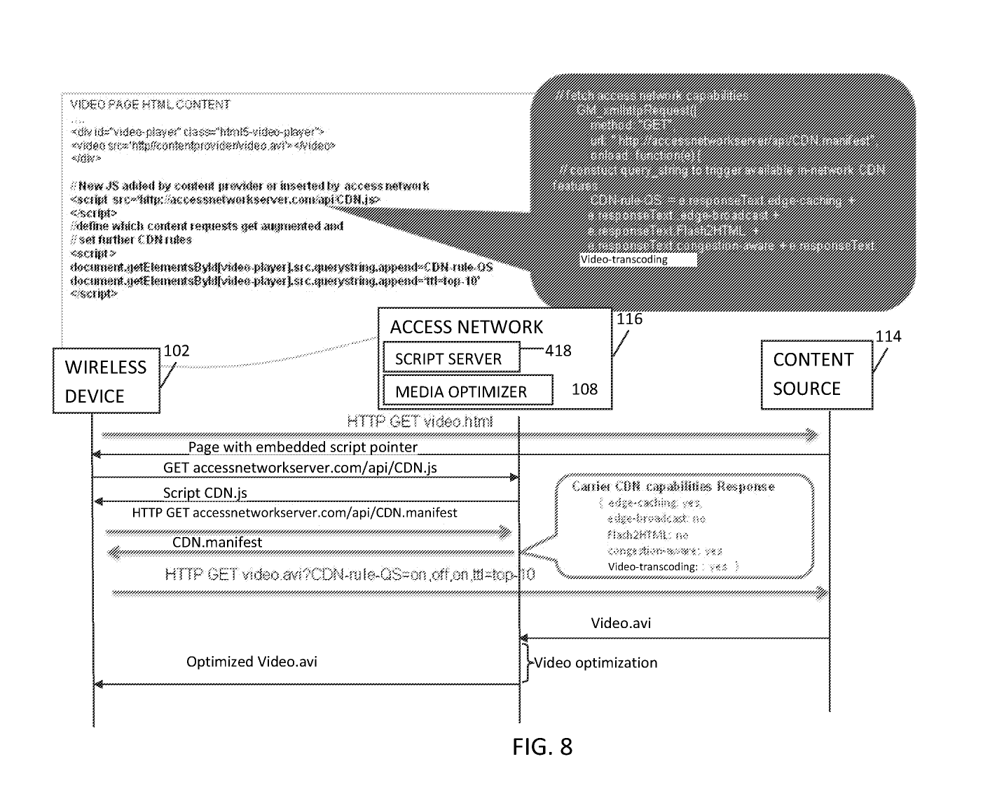

FIG. 8 illustrates another set of exemplary message interactions between an end-user, the access network 116 that includes the media optimizer 108 and the script server 418, and the content source 114. In a first operation, an HTTP GET request “GET video.html” is sent from the wireless device to the content source. The HTTP GET request is for a webpage containing video content and the content source generates and sends an HTTP response back to the wireless device. As shown in FIG. 8, the HTTP response includes the requested webpage with a script pointer. The script pointer may be inserted in the webpage by the content source and/or the access network. For example, the access network may intercept an HTTP response from the content source and insert the script pointer. An example of the webpage is shown in FIG. 8, which includes an embedded script pointer that points to the URL, “http://accessnetworkserver.com/api/CDN.js”. The URL “accessnetworkserver.com” is merely used to represent the URL address of a server in the access network that can store scripts. The URL addresses of servers in the access network are not limited to the above-identified URL. In this example, the script pointer points to a script that when executed, runs an API in an end-user device. An example of the script is shown in FIG. 8. The API may generate a part of the interface 320 or the compete interface 320 of FIG. 3. As shown in FIG. 8, the script contains a link to the URL, “http://accessnetworkserver.com/api/CDN.manifest”.

Upon receiving the HTTP response with the embedded script pointer, the wireless device 102 makes an HTTP request “GET accessnetworkserver.com/api/CDN.js” to the access network 116. In response to receiving the script request, the access network provides the requested script to the wireless device. The wireless device runs the script on a web browser and makes an HTTP request “GET accessnetworkserver.com/api/CDN.manifest” to the access network. The access network responds to the HTTP request “GET accessnetworkserver.com/api/CDN.manifest” with optimization capabilities of the access network. Upon receiving the optimization capabilities of the access network, the wireless device selects from video quality options and/or video optimization options that are offered by the access network or uses a default video quality option and/or video optimization option that can be implemented by the access network. After a video optimization selection is made, the script enables the wireless device to send an HTTP GET message “GET video.avi” that includes an optimization command (e.g., a query string), which is recognized by the access network and triggers video optimization by the media optimizer 108. For example, on-the-fly CDN rules are appended to the video request by the client browser as the optimization command (e.g., as a query string). The media optimizer can transparently intercept the HTTP GET message and interprets the optimization command (e.g., the query string) to trigger video optimization. After receiving the HTTP request for video content, the content source 114 sends the requested video content “video.avi” to the wireless device. The media optimizer intercepts the video content, performs video optimization as needed, and sends the video content to the wireless device. In an embodiment, the media optimizer determines that the requested video content (identified by “video.avi”) is not locally accessible (e.g. cached or optimized previously) in the access network and sends a request for video content on behalf of the wireless device. When the requested video content is received from the content source at the media optimizer, the media optimizer applies media optimization on the requested content. Exemplary message interactions illustrated in FIGS. 7 and 8 can be applied to video content and/or non-video content such as text files, webpage files, image files, audio files, or any combination thereof.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device). Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

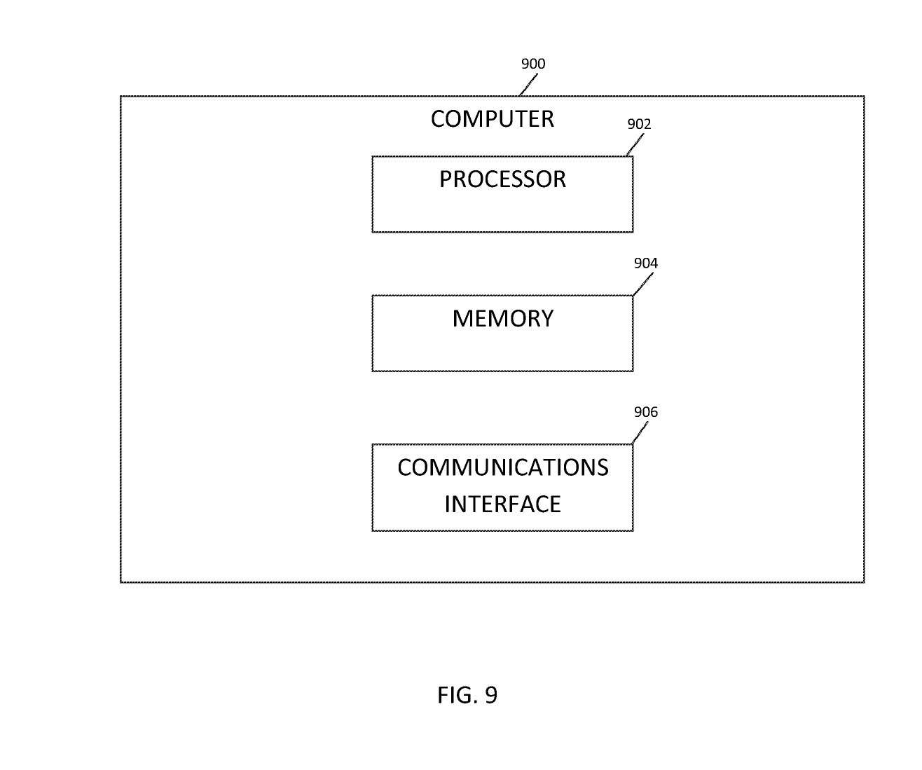

In an embodiment, the functionality of at least one component of the content delivery system 100 or 400, such as the media optimizer 108 or 208, the traffic router 232, the media optimization platform 232 or the script server 418, can be performed by a computer, such as a server or router, which executes computer readable instructions. FIG. 9 depicts a computer 900 that includes a processor 902, memory 904, and a communications interface 906. The processor may include a multifunction processor and/or an application-specific processor. Examples of processors include the PowerPC™ family of processors by IBM and the x86 family of processors by Intel. The memory within the computer may include, for example, storage medium such as read only memory (ROM), flash memory, RAM, and a large capacity permanent storage device such as a hard disk drive. The communications interface enables communications with other computers via, for example, the Internet Protocol (IP). The computer executes computer readable instructions stored in the storage medium to implement various tasks as described above.

In an embodiment, at least one element of the content delivery system 100 or 400, such as the media optimizer 108 or 208, the traffic router 232, the media optimization platform 232 or the script server 418, is a logical representation, in which components of the element may be located in a single device or distributed across multiple devices.

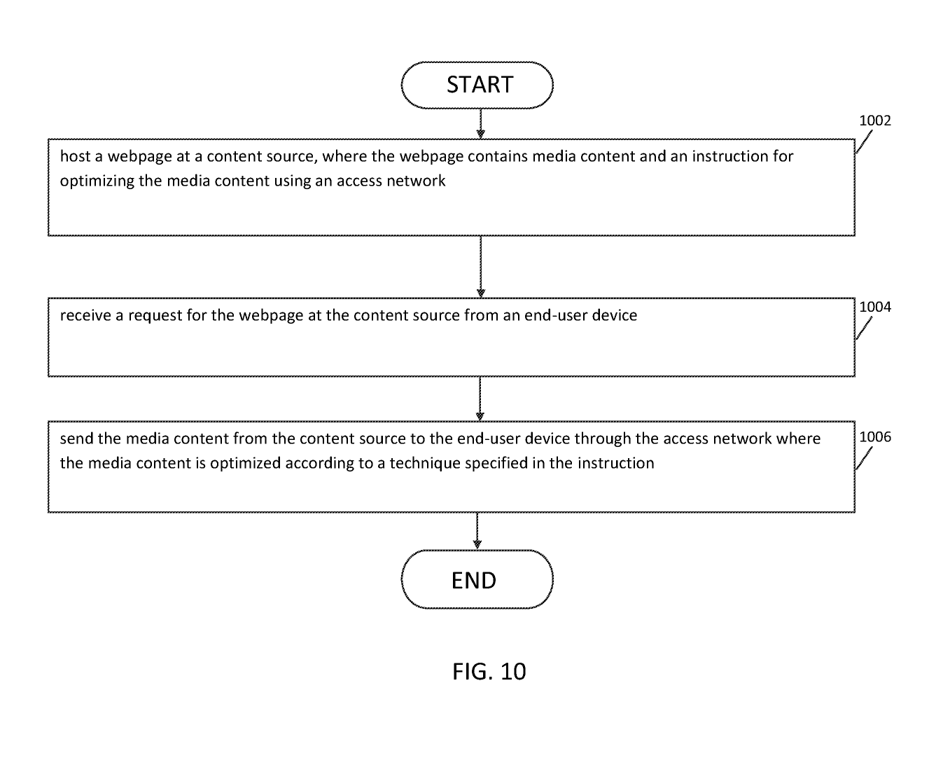

FIG. 10 is a process flow diagram of a method for providing media optimization in accordance with an embodiment of the invention. At block 1002, a webpage is hosted at a content source, where the webpage contains media content and an instruction for optimizing the media content using an access network. At block 1004, a request for the webpage is received at the content source from an end-user device. At block 1006, the media content is sent from the content source to the end-user device through the access network, where the media content is optimized according to a technique specified in the instruction.

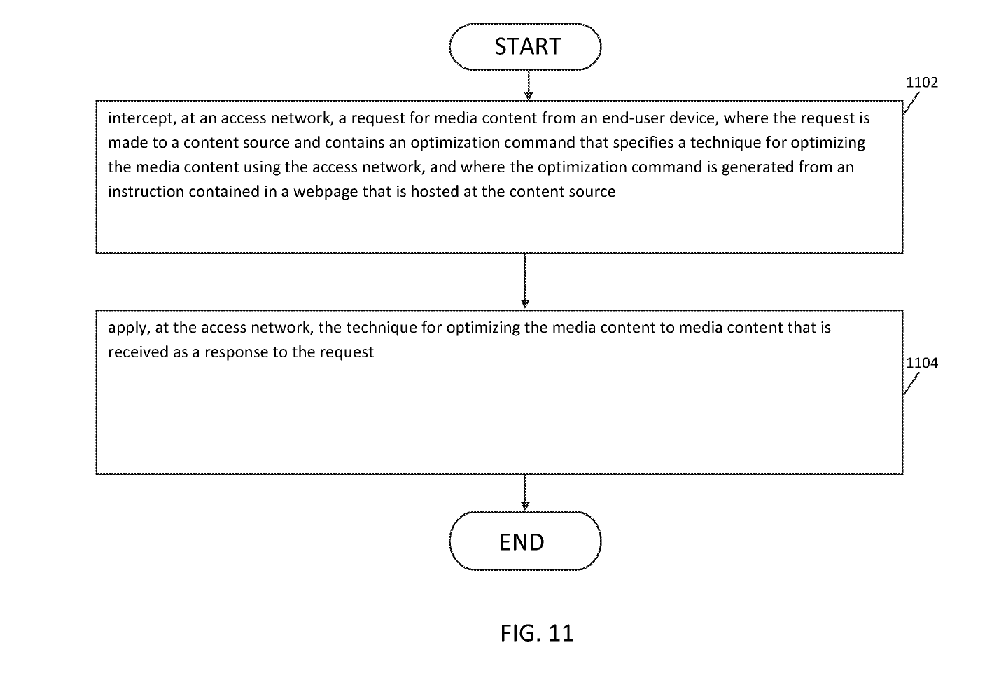

FIG. 11 is a process flow diagram of a method for providing media optimization in accordance with another embodiment of the invention. At block 1102, a request for media content from an end-user device is intercepted at an access network, where the request is made to a content source and contains an optimization command that specifies a technique for optimizing the media content using the access network, and where the optimization command is generated from an instruction contained in a webpage that is hosted at the content source. At block 1104, the technique for optimizing the media content is applied to media content that is received as a response to the request at the access network.

Embodiments of the invention can be applied to any type of content. For example, the content may include, without limitation, one or more webpage files, one or more text files, one or more image files, one or more audio files, or one or more video files, or any combination thereof. Because of the large size and time sensitive nature of video content, embodiments of the invention can be especially valuable for improving end-user experiences of viewing video content.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Additional embodiments are disclosed in the following Clauses:
1. A method for providing media optimization, the method comprising:
   hosting a webpage at a content source, wherein the webpage contains media content and an instruction for optimizing the media content using an access network;
   receiving a request for the webpage at the content source from an end-user device; and
   sending the media content from the content source to the end-user device through the access network where the media content is optimized according to a technique specified in the instruction.
2. The method of clause 1, wherein the instruction comprises a script pointer that points to a script in a script server.
3. The method of clause 2, wherein the script server is located within the access network.
4. The method of clause 2, wherein the script server is located within the content source.
5. The method of clause 1, wherein the technique is one of:
   codec transforming;
   encoding;
   size adaptation;
   bit rate adaptation;
   caching;
   transcoding;
   live stream handling;
   content broadcast;
   bandwidth shaping.
6. The method of clause 1, wherein the technique is for one of reducing a content file size according to a congestion condition of the access network and delivering content payload more efficiently according to the congestion condition of the access network.
7. A method for providing media optimization, the method comprising: intercepting, at an access network, a request for media content from an end-user device, wherein the request is made to a content source and contains an optimization command that specifies a technique for optimizing the media content using the access network, and wherein the optimization command is generated from an instruction contained in a webpage that is hosted at the content source; and
   applying, at the access network, the technique for optimizing the media content to media content that is received as a response to the request.
8. The method of clause 7, wherein the optimization command comprises one of a Hypertext Transfer Protocol (HTTP) header and an Internet Protocol (IP) header.
9. The method of clause 7, wherein the optimization command comprises one of a query string associated with the request and a request domain modification associated with the request.
10. The method of clause 7, wherein the instruction comprises a script pointer that points to a script in a script server.
11. The method of clause 10, wherein the script server is located within the access network.
12. The method of clause 10, wherein the script server is located within the content source.
13. The method of clause 10, wherein the script comprises a link to a file that describes an optimization capacity of the access network.
14. The method of clause 7, wherein the technique is one of:
   codec transforming;
   encoding;
   size adaptation;
   bit rate adaptation;
   caching;
   transcoding;
   live stream handling;
   content broadcast; and
   bandwidth shaping
15. The method of clause 7, wherein the technique is for one of reducing a content file size according to a congestion condition of the access network and delivering content payload more efficiently according to the congestion condition of the access network.
16. A system for providing media optimization, the system comprising:
   a traffic router configured to intercept, at an access network, a request for media content from an end-user device, wherein the request is made to a content source and contains an optimization command that specifies a technique for optimizing the media content using the access network, and wherein the optimization command is generated from an instruction contained in a webpage that is hosted at the content source; and
   a media optimization platform configured to apply, at the access network, the technique for optimizing the media content to media content that is received as a response to the request.
17. The system of clause 16, wherein the optimization command comprises one of a Hypertext Transfer Protocol (HTTP) header and an Internet Protocol (IP) header.
18. The system of clause 16, wherein the optimization command comprises one of a query string associated with the request and a request domain modification associated with the request.
19. The system of clause 16, wherein the instruction is a script pointer that points to a script, wherein the system further comprises a script server configured to store the script.
20. The system of clause 19, wherein the script comprises a link to a file that describes an optimization capacity of the access network.
21. The system of clause 16, wherein the technique is one of:
   codec transforming;
   encoding;
   size adaptation;
   bit rate adaptation;
   caching;
   transcoding;
   live stream handling;
   content broadcast; and
   bandwidth shaping.
22. The system of clause 16, wherein the technique is for reducing a content file size according to a congestion condition of the access network.

Although specific embodiments of the invention have been described and illustrated, the invention is not to be limited to the specific forms or arrangements of parts so described and illustrated. The scope of the invention is to be defined by the claims appended hereto and their equivalents.

1. A method for enabling optimization, in an access network, of media content downloadable from a content source to a user device connected to the access network, the method comprising:
receiving at the user device, via the access network, data for use in generating a user interface for accessing the media content from a content source;
executing the data at the user device to generate the user interface;
sending from the user device, in response to a selection made by a user based on a set of one or more user selectable options generated by the data, a media optimization instruction to the access network;
receiving at the user device media content downloaded from the content source, the media content having been optimized in accordance with an optimization technique by the access network in response to the optimization instruction.

2. The method of claim 1, the method comprising:
receiving at the user device a file containing a pointer to a location in a network of the data for use in generating the user interface;
sending a request to the data network for the data;
receiving the data at the user device

3. The method of claim 2 wherein the data is a script and the pointer is a script pointer that points to a script in a script server.

4. The method of claim 2, wherein the location is within the access network.

5. The method of claim 2, wherein the location is within the content source.

6. The method of claim 5, wherein the file is a web page.

7. The method of claim 1, wherein the technique is one of:
codec transforming;
encoding;
size adaptation;
bit rate adaptation;
caching;
transcoding;
live stream handling;
content broadcast; and
bandwidth shaping.

8. The method of claim 7, wherein the technique is for one of reducing a content file size according to a congestion condition of the access network and delivering content payload more efficiently according to the congestion condition of the access network.

9. The method of claim 8, further comprising: using the user interface to present the media content to a user.

10. The method of claim 9, wherein the optimization command comprises one of a Hypertext Transfer Protocol (HTTP) header and an Internet Protocol (IP) header.

11. The method of claim 1, wherein the optimization command comprises one of a query string associated with a request sent from the user device for the media content and a request domain modification associated with the request.

12. The method of claim 1, wherein the data comprises a link to a file that describes an optimization capacity of the access network.

13. The method of claim 1, wherein the technique is specified in the instruction.

14. A method for optimizing, at an access network, media content downloadable from a content source to a user device connected to the access network, the method comprising:
receiving at the access network a media optimization instruction sent from the user device in response to an optimization selection made by a user using a user interface at the user device, the user interface for accessing the media content from the content source;
optimizing using an optimization technique, at the access network, in response to the instruction, media content being downloaded to the user device.

15. The method of claim 14, wherein the technique is one of:
codec transforming;
encoding;
size adaptation;
bit rate adaptation;
caching;
transcoding;
live stream handling;
content broadcast; and
bandwidth shaping.

16. The method of claim 14, wherein the technique is for one of reducing a content file size according to a congestion condition of the access network and delivering content payload more efficiently according to the congestion condition of the access network.

17. The method of claim 16, wherein the optimization instruction comprises one of a Hypertext Transfer Protocol (HTTP) header and an Internet Protocol (IP) header.

18. The method of claim 14, wherein the optimization instruction comprises one of a query string associated with a request sent from the user device for the media content and a request domain modification associated with the request.

19. The method of any of claim 18, wherein the technique is specified in the instruction.

20. A method for enabling optimization, in an access network, of media content downloadable to a user device connected to the access network, the method comprising:
storing data for generating a user interface at the user device, the user interface being arranged to access the media content from a content source, and the data being arranged to cause a media optimization instruction to be sent to the access network in response to a selection made by a user based on a set of one or more user selectable options generated by the data; and
sending the data to the user device in response to a request received from the user device.

21-34. (canceled)
